(19) United States
(12) Patent Application Publication
(10) Pub. No.: US 2016/0336116 A1
(43) Pub. Date: Nov. 17, 2016

(54) METHOD FOR PRODUCING TUNGSTEN SOLID ELECTROLYTIC CAPACITOR ELEMENT

(71) Applicant: SHOWA DENKO K.K., Tokyo (JP)

(72) Inventors: Kazumi NAITO, Tokyo (JP); Shoji YABE, Tokyo (JP)

(73) Assignee: SHOWA DENKO K.K., Tokyo (JP)

(21) Appl. No.: 15/111,904

(22) PCT Filed: Oct. 30, 2014
(86) PCT No.: PCT/JP2014/078949

§ 371 Date: Jul. 15, 2016

(30) Foreign Application Priority Data
Jan. 20, 2014 (JP) 2014-007764

(51) Int. Cl. H01G 9/052; H01G 9/07; H01G 9/042; H01G 9/00

(52) U.S. Cl. CPC H01G 9/0525; H01G 9/0036; H01G 9/07; H01G 9/042

(57) ABSTRACT

A method for producing a capacitor element, which includes aging process A of applying a voltage of ⅓ to ⅘ of the chemical formation voltage to the capacitor element having an electrically conductive layer formed on an anode body under conditions of a temperature of 15 to 50° C. and a humidity of 75 to 90% RH; or a method for producing a capacitor element including, before the above-mentioned process A, process B of retaining the capacitor element having an electrically conductive layer formed on the anode body at a temperature more than 50° C. and 85° C. or less and a humidity of 50 to 90% RH.

### TECHNICAL FIELD

The present invention relates to a method for producing a tungsten capacitor element. Specifically, the present invention relates to a method for producing a tungsten solid electrolytic capacitor element having a carbon layer, which element has improved leakage current (LC) characteristics.

### BACKGROUND ART

With the progress of small-size, high-speed and lightweight electronic devices such as cellular phones and personal computers, the capacitor used for these electronic devices is demanded to have a smaller size, a larger capacitance and a lower ESR.

As an example of such a capacitor, the electrolytic capacitor has been proposed, which capacitor is produced by anodically oxidizing an anode body for capacitors comprising a sintered body made of a valve-acting metal powder such as tantalum which can be anodized to form a dielectric layer made of the oxide of the metal on the surface of the anode body.

The electrolytic capacitor using tungsten as a valve-acting metal and employing the sintered body of the tungsten powder as an anode body can attain a larger capacitance compared to the electrolytic capacitor obtained at the same formation voltage by employing the anode body of the same volume using the tantalum powder having the same particle diameter. However, the electrolytic capacitor having the sintered body of the tungsten powder has had a problem of a large leakage current (LC).

The present inventors have found that the problem of LC characteristics can be solved by using a tungsten powder containing a specific amount of tungsten silicide in a particle surface region, and proposed a tungsten powder containing tungsten silicide in a particle surface region and having a silicon content of 0.05 to 7 mass %, an anode body for a capacitor comprising a sintered body of the powder, an electrolytic capacitor comprising the anode body, and a production method thereof (Patent Document 1: WO 2012/086272 (US Patent Publication No. 2013/0277626)).

However, a tungsten capacitor element produced by sequentially forming a dielectric layer, a semiconductor layer, a carbon layer and a conductor layer on a predetermined part of the anode body, which was obtained by forming a powder mainly comprising tungsten and then sintering the formed body, has had a problem that, when carbon particles in the carbon layer are brought into contact with the dielectric layer, they reduce the dielectric layer to thereby deteriorates the LC.

As the prior art relevant to the aging technique employed in the present invention, Patent Document 2 (JP 2005-57255 A) discloses a method for producing a solid electrolytic capacitor, wherein a solid electrolytic capacitor element comprises an anode body composed of a material containing an earth-acid metal such as niobium, a dielectric layer formed on the anode body, a semiconductor layer formed on the dielectric layer, and an electrically conducting layer stacked on the semiconductor layer, and the solid electrolytic capacitor element is subjected to molding with a resin, curing and then voltage applying (aging) treatment, which method comprises repeating a step of leaving the resin-molded body to stand at a temperature of 225 to 305° C. and a step of aging it are sequentially repeated after the above steps of molding with resin and curing.

Patent Document 3 (JP H06-208936 A) discloses a production method, wherein a discrete-type solid electrolytic capacitor with a built-in fuse is sealed with resin and subsequently subjected to aging.

Patent Document 4 (JP H11-145007 A) discloses a production method, wherein aging is conducted at a maximum operation temperature of the capacitor or more at the time of coating with resin.

However, the problem of leakage current in a tungsten capacitor having a carbon layer cannot be solved by the methods described in these patent documents.

### PRIOR ART

### Patent Documents

Patent Document 1: WO 2012/086272
Patent Document 2: JP 2005-208936 A
Patent Document 3: JP H06-208936 A
Patent Document 3: JP H11-145007 A

### SUMMARY OF INVENTION

### Problem to be Solved by Invention

An object of the present invention is to provide a method for producing a capacitor element which is improved particularly in LC characteristics, in a capacitor element comprising a sintered body obtained by forming a powder mainly comprising tungsten and sintering the formed body, having a dielectric layer, a semiconductor layer, a carbon layer and an electrically conducting layer sequentially formed on a predetermined part of the anode body.

### Means to Solve the Problem

The present inventors have found that the leakage current characteristics of a capacitor element can be improved by providing a process of applying a voltage lower than the chemical formation voltage at a predetermined low temperature under conditions of a constant temperature and a humidity (process A) to a capacitor element having a semiconductor layer, a carbon layer and an electrically conductive layer formed sequentially on a dielectric layer.

The present inventors have also found that the leakage characteristics can be further improved by conducting process A after providing a process of retaining a tungsten capacitor element without applying a voltage at a temperature higher than that of process A under conditions of a constant temperature and a humidity for a predetermined time period so as to once increase the LC value (process B) prior to process A. Thus, they have accomplished the present invention.

That is, the present invention relates to the method for producing a tungsten capacitor element as described below.
[1] A method for producing a capacitor element in which a dielectric layer, a semiconductor layer, a carbon layer and an electrically conductive layer are sequentially formed on a predetermined part of an anode body obtained by forming a powder mainly comprising tungsten and sintering the formed body, comprising process A of applying a voltage of ⅓ to ⅘ of the chemical formation voltage to the capacitor element having the electrically conductive layer formed on the anode body under conditions of a temperature of 15 to 50° C. and a humidity of 75 to 90% RH.
[2] A method for producing a capacitor element in which a dielectric layer, a semiconductor layer, a carbon layer and an electrically conductive layer are sequentially formed on a predetermined part of an anode body obtained by forming a powder mainly comprising tungsten and sintering the formed body, comprising process B of retaining the capacitor element having the electrically conductive layer formed on the anode body without applying a voltage at a temperature more than 50° C. and 85° C. or less and a humidity of 50 to 90% RH and then process A of applying a voltage of ⅓ to ⅘ of the chemical formation voltage to the capacitor element under conditions of a temperature of 15 to 50° C. and a humidity of 75 to 90% RH.
[3] The method for producing a capacitor element as described in [1] or [2] above, wherein the powder mainly comprising tungsten contains tungsten silicide only in a particle surface region and having a silicon content of 0.05 to 7.0 mass %.

### Effects of Invention

The production method of the present invention makes it possible to improve LC characteristics of a tungsten solid electrolytic capacitor having a carbon layer.

In a solid electrolytic capacitor (in particular, a tungsten solid electrolytic capacitor) having a carbon layer, the carbon particles in the carbon layer reduce the dielectric layer when the particles are brought into contact with the dielectric layer, and thus causes deterioration in LC characteristics. The present invention has an effect of improving LC characteristics of a solid electrolytic capacitor element having a carbon layer, in particular, a tungsten solid electrolytic capacitor element having a dielectric layer produced by subjecting an anode body made of tungsten having low oxygen affinity to chemical formation. According to the present invention, a solid electrolytic capacitor product having rated voltage of 6.3 V can be attained at a low formation voltage.

### MODE FOR CARRYING OUT INVENTION

A commercially available tungsten powder can be used as a tungsten powder serving as a material of an anode body. A tungsten powder having a smaller particle diameter than those of commercially available tungsten powder can be obtained by, for example, pulverizing the tungsten trioxide powder under hydrogen atmosphere; or reducing the tungstic acid and halogenated tungsten using a reducing agent such as hydrogen and sodium and appropriately selecting the reducing conditions.

Also, the tungsten powder can be obtained by reducing the tungsten-containing mineral directly or through several steps and by selecting the reducing conditions.

As a tungsten powder for a capacitor, a granulated tungsten powder facilitates formation of fine pores in an anode body and is preferable (hereinafter, the granulated tungsten powder may be referred to as the “granulated powder”).

Using each of the above-described ungranulated tungsten powders (hereinafter may be referred to as the “ungranulated powder”), the fine pore distribution of the granulated powder further may be adjusted in the manner as JP-A-2003-213302 discloses on the case of a niobium powder.

From a raw material tungsten powder, a tungsten powder having a smaller particle diameter can be obtained by pulverizing the tungsten trioxide powder under hydrogen atmosphere using a pulverizing media (The raw material tungsten powder may be referred to as “a coarse powder” in a simple term). As the pulverizing media, a pulverizing media made of the metal carbide such as tungsten carbide and titanium carbide is preferable. In the case of using these metal carbides, fine fragments of the pulverizing media is less likely to be mixed into the powder. Preferred is a pulverizing media made of tungsten carbide.

A tungsten powder disclosed by Patent Document 1, the particle surface region of which is made to be tungsten silicide so as to make the silicon content within a specific range, is preferably used.

The tungsten powder, in which the particle surface region is silicified, can be obtained by, for example, mixing the silicon powder well into the tungsten powder and allowing the mixture to react by heating under reduced pressure. In the case of using this method, the silicon powder reacts with the tungsten from the surface of the tungsten particles and tungsten silicide such as W₅Si₃ is formed and localized generally within 50 nm from the particle surface. Hence, the core of the primary particles remains as a highly-conducting metal, which suppresses the equal serial resistance of the anode body produced using the tungsten powder, and is preferable. The tungsten silicide content can be adjusted by the silicon amount to be added.

As for any kinds of tungsten silicides, the silicon content can be used as an index for the tungsten silicide content. The silicon content of the whole tungsten powder is preferably 0.05 to 7 mass %, and particularly preferably 0.2 to 4 mass %. The tungsten powder containing silicon within the above-mentioned range is a preferable powder for use in the electrolytic capacitors, imparting good LC characteristics to the capacitors. When the silicon content is less than 0.05 mass %, the powder is not capable of imparting good LC characteristics to the capacitors in some cases. When the silicon content exceeds 7.0 mass %, the tungsten powder contains too much tungsten silicide and fails to form a dielectric layer well in some cases when a sintered body obtained by sintering the powder is processed as an anode body by chemical formation.

When the above-mentioned low-pressure condition is set to 10⁻¹ Pa or lower, preferably 10⁻³ Pa or lower, for conducting silicification, the oxygen content of the tungsten powder can be configured to a preferable range of 0.05 to 8.0 mass %.

The reaction temperature is preferably 1,100° C. to 2,600° C. The smaller the particle diameter of the silicon to be used, the silicification can be carried out at a lower temperature. However, when the reaction temperature is lower than 1,100° C., it takes time for silicification. When the reaction temperature exceeds 2,600° C., the silicon comes to evaporate easily, which will require the maintenance for the high-temperature vacuum furnace.

As the tungsten powder used in the present invention, a powder further containing in the particle surface region at least one member selected from tungsten containing a nitrogen solid solution, tungsten carbide and tungsten boride can be suitably used. In the tungsten containing a nitrogen solid solution in the present invention, all the nitrogen does not necessarily need to be in the form of a solid solution and part of nitrogen may be present as a tungsten nitride and adsorbed nitrogen on the particle surface.

As an example of the method for allowing a nitrogen solid solution to be contained in a tungsten powder in the particle surface region, there is a method of retaining the tungsten powder under nitrogen atmosphere at 350 to 1,500° C. under reduced pressure from several minutes to several hours.

A step of incorporating a nitrogen solid solution may be conducted at the time of the high-temperature treatment under reduced pressure for silicifying the tungsten powder, or conducted prior to the silicification. Further, the step of incorporating a nitrogen solid solution can be conducted at the time of producing a primary powder, after the production of a granulated powder, or after the production of a sintered body. Thus, it is not specified when the step of incorporating a nitrogen solid solution is conducted during the production process of a tungsten powder, but it is preferable to allow the tungsten powder to have a nitrogen content of 0.01 to 1.0 mass % in an early stage of the production process. The treatment of incorporating a nitrogen solid solution can prevent excessive oxidation of the powder when the powder is handled in air.

As an example of the method for carbonizing a part of the surface of tungsten powder in which the particle surface region is silicified and/or contains a nitrogen solid solution, there is a method of retaining the tungsten powder at 300 to 1,500° C. under reduced pressure in a high temperature vacuum furnace using carbon electrodes for from several minutes to several hours. It is preferable to perform the carbonization so as to make the carbon content to 0.001 to 0.50 mass % by selecting the temperature and period of time.

It is not specified when the carbonization is conducted during the production process like the case for the above-mentioned treatment of incorporating a nitrogen solid solution. When a silicified tungsten powder is retained in the furnace using carbon electrodes under predetermined conditions, the carbonization and the nitridation occur simultaneously, which enables the production of the tungsten powder in which the particle surface region is silicified, is carbonized, and contains a nitrogen solid solution.

As an example of the method for boronizing a part of the surface of the tungsten powder in which the particle surface region is silicified, carbonized and/or contains a nitrogen solid solution there is a method of mixing a powder of boron or a compound containing elemental boron as a boron source with the tungsten powder in advance and granulating the mixture. It is preferable to boronize the powder so as to have the boron content of 0.001 to 0.10 mass %. Good LC characteristics can be attained when the boron content is within the above-mentioned range. The timing of the boronization is the same as mentioned in the timing of the nitridation. It is not specified when the boronization is conducted during the production process like the case for the above-mentioned treatment of incorporating a nitrogen solid solution. When the tungsten powder, in which the particle surface region is silicified and contains a nitrogen solid solution, is granulated by mixing the powder with a boron source and placing it in a furnace using carbon electrodes, it is possible to produce a tungsten powder in which the particle surface region is silicified, carbonized and boronized and contains a nitrogen solid solution. When the boronization is performed to obtain a predetermined boron content, the LC characteristics are further improved in some cases.

At least one member of a tungsten powder containing a nitrogen solid solution, a carbonated tungsten powder and a boronized tungsten powder may be added to the tungsten powder in which the particle surface region is silicified. In this case, it is also preferable to blend each element of silicon, nitrogen, carbon and boron in an amount so that the each content satisfies the above-mentioned range.

The above-mentioned methods for incorporating a nitrogen solid solution, carbonization and boronization were given for the case using the tungsten powder in which the particle surface region is silicified in advance. It is also possible to subject the tungsten powder to at least one of the incorporation of a nitrogen solid solution, carbonization, and boronization in advance and to silicify the surface region. A powder of simple tungsten may be mixed with the tungsten powder obtained by subjecting a tungsten powder in which the particle surface region is silicified to at least one of the incorporation of a nitrogen solid solution, carbonization and boronization. In this case each element of silicon, nitrogen, carbon and boron is preferably blended in an amount so that the each content satisfies the above-mentioned range.

The oxygen content of the whole tungsten powder of the present invention is preferably 0.05 to 8.0 mass %, and more preferably 0.08 to 1.0 mass %.

As a method for controlling the oxygen content to 0.05 to 8.0 mass %, there is a method of oxidizing the surface of the tungsten powder in which the particle surface region is silicified and further subjected to at least one of incorporation of a nitrogen solid solution, carbonization and boronization. Specifically, nitrogen gas containing oxygen is introduced at the time of taking out the powder from a high temperature vacuum furnace at the time of producing a primary powder or a granulated powder of each powder. In case that the temperature at the time of taking out from the high temperature vacuum furnace is lower than 280° C., oxidation takes priority over incorporation of a nitrogen solid solution. By feeding the gas gradually, a predetermined oxygen content can be obtained. By making each of the tungsten powders have a predetermined oxygen content in advance, it is possible to reduce the deterioration due to the irregular excessive oxidation caused by the formation of a natural oxide film having an uneven thickness during the subsequent processes for producing anode bodies for electrolytic capacitors using the powder. In case that the oxygen content is within the above-mentioned range, the LC characteristics of the produced electrolytic capacitors can be kept better. In the case when the incorporation of a nitrogen solid solution is not performed in this process, an inert gas such as argon and helium may be used instead of the nitrogen gas.

The phosphorous content of the whole tungsten powder of the present invention is preferably from 0.0001 to 0.050 mass %.

As an example of the methods for incorporating the phosphorous element in an amount of 0.0001 to 0.050 mass % in the tungsten powder in which the particle surface region is silicified and further subjected to at least one of incorporation of a nitrogen solid solution, carbonization and boronization, there is a method of producing the phosphorous-containing powder by placing phosphorous or a phosphorous compound in the high temperature vacuum furnace as a phosphorous source at the time of producing a primary powder or a granulated powder of each tungsten powder. It is preferable to incorporate phosphorous in the tungsten powder so as to make the phosphorous content within the above-mentioned range by controlling the amount of the phosphorous source and the like because the physical breakdown strength of the anode bodies produced thereof can be improved in some cases. When the phosphorus content falls within the above-mentioned range, the LC characteristics of an electrolytic capacitor made from the powder are further improved.

In the tungsten powder in which the particle surface region is silicified, it is preferable to keep the total content of impurity elements other than each element of silicon, nitrogen, carbon, boron, oxygen and phosphorous to 0.1 mass % or lower to attain better LC characteristics. In order to keep the content of these elements to the above-mentioned value or lower, the amount of the impurity elements contained in the raw materials, pulverizing member to be used, containers and the like should be kept at a lower level.

In the present invention, a dielectric layer is formed on the surface of a sintered body (anode body) obtained by sintering each of the above-mentioned tungsten granulated powders.

A dielectric layer is obtained by subjecting the sintered body to chemical formation in an electrolytic solution containing an oxidizing agent as an electrolyte and drying it at a high temperature. A semiconductor layer comprises at least one layer of conductive polymer and is formed by a known method. A carbon layer and an electrically conductive layer are sequentially laminated on a predetermined part of the semiconductor layer according to a known method. Here, an electrically conductive layer can be formed by applying a silver paste and drying it. A paste using a silver-coated copper powder, silver-coated nickel powder, or a mixed powder of silver and copper, instead of a silver powder contained in a silver paste, may be used. In addition to a method using a silver paste, an electrically conductive layer may be formed by silver plating or lead-free soldering such as tin soldering. The LC characteristics of the thus-obtained capacitor element is improved by either of the two methods as described below.

The two methods are effective in obtaining a capacitor element having a higher ratio of a rated voltage to the formation voltage: i.e. a capacitor element having a higher capacitance and a higher rated voltage compared to other elements of the same shape. For example, while a capacitor element obtained by forming a dielectric layer by means of chemical formation at 10 V generally has a rated voltage of 2.5 V or 4 V, it is possible to attain a rated voltage of 6.3 V according to the present invention.

(1) Process A

Process A is an aging process of applying a voltage of ⅓ to ⅘ of the chemical formation voltage to a capacitor element under conditions of a temperature of 15 to 50° C. and a humidity of 75 to 90% RH (relative humidity). Specifically, for example, the aging is conducted by placing a capacitor element in a low-temperature thermo-hygrostat at 15 to 50° C. and 75 to 90% RH and applying a voltage of ⅓ to ⅘ of the chemical formation voltage to the capacitor element. It is not necessary to maintain the temperature and the humidity at a constant value as long as they fall within the above-mentioned range. By the aging in Process A, the LC value at a voltage of 60 to 70% of the formation voltage can be controlled to 0.1 CV or less. Among the tungsten capacitor elements produced without Process A, none has an LC value of 0.1 CV or less at a voltage of 60 to 70% of the formation voltage. As to tantalum capacitor elements and niobium capacitor elements made from an anode body mainly comprising tantalum and niobium and having the same volume and the same capacity, most of the elements have an LC value of 0.1 CV or less at a voltage of 60 to 70% of the formation voltage even without conducting the operation of Process A, and show little improvement in the LC value if Process A is conducted.

If the temperature in Process A is lower than 15° C., it takes time to improve the LC characteristics, which results in higher cost and is undesirable. When the temperature exceeds 50° C., the LC characteristics deteriorate in some cases. When the humidity is less than 75% RH, it is difficult to obtain the effect. If the humidity is 90% or more, the color of the electrically conductive layer (silver layer) becomes darker in color and a part of the silver layer may fall away in some cases. When the voltage to be applied is less than ⅓ of the formation voltage, it takes time to improve the LC characteristics and results in higher cost. When the voltage to be applied exceeds ⅘ of the formation voltage, it leads to the emergence of the elements in which the LC characteristics are not improved. The time period for applying a voltage varies depending on the size of the element, the voltage and the humidity conditions, and therefore is to be appropriately determined by, for example, a preliminary experiment.

(2) Process B+Process A

Process B is a process of retaining a capacitor element under conditions of a temperature of higher than 50° C. and 85° C. or less and a humidity of 50 to 90% RH without applying a voltage. Specifically, for example, a capacitor element is placed in a high-temperature thermo-hygrostat at a temperature of higher than 50° C. and 85° C. or less and 50 to 90% RH and retaining the element for a predetermined time period without applying a voltage. It is not necessary to maintain the temperature and the humidity at a constant value as long as they fall within the above-mentioned range. The LC value of the tungsten capacitor element is to be once increased in Process B. Subsequently, Process A is conducted. As a result, the LC value at a voltage of 60 to 70% of the formation voltage becomes 0.1 CV or less. The effect of improving the LC value is greater compared to the case of conducting Process A alone. Although a voltage may be applied in Process B, the capacitor element shows no improvement in the LC value at this stage even if a voltage is applied.

When a capacitor element is impaired (the LC characteristics are deteriorated) at first in Process B and the temperature is set to 50° C. or less, the element shows no significant deterioration in the LC characteristics. It is also possible to set the temperature to more than 85° C., it causes excessive deterioration in LC values and the element shows no improvement in LC values in the subsequent Process A in some cases. When the humidity is set to less than 50%, the LC value is not to be deteriorated in some cases. Although the humidity may be set to a value exceeding 90%, it tends to lead to deterioration in facilities and is disadvantageous in terms of the maintenance. The retention time period in Process B varies depending on the size of the element and the humidity conditions, the conditions are determined by, for example, a preliminary experiment.

Both of the above-mentioned Process A, and Process B and Process A, can be conducted in the atmosphere, but may also be conducted under an inert atmosphere. In addition, after conducting Process A, or Process B and Process A, excessive moisture contained in the element may be removed by heating at atmospheric pressure or under reduced pressure. To remove moisture, for example, the element is to be dried in the atmosphere at 105° C.

An electrolytic capacitor is formed, that comprises an anode body subjected to the aging treatment by conducting Process A only or Process B and Process A as one electrode (anode), a counter electrode (cathode) containing a semiconductor layer, and a dielectric body interposed between the electrodes.

### EXAMPLES

The present invention is described below by referring to Examples and Comparative Examples, but the present invention is not limited thereto.

In the present invention, the measurement of the particle diameter (average particle diameter and particle diameter range), the bulk density, the specific surface area and elemental analysis were carried out by the methods described below.

The particle diameter of the powder (volume-average particle diameter) was measured by using HRA9320-X100 manufactured by Microtrac Inc. (a laser-diffraction scattering method particle size distribution analyzer). Specifically, volume-based particle diameter distribution was measured with the analyzer and a particle size value (D50; μm) when the accumulated volume % corresponded to 50 volume % in the accumulated particle size distribution was designated as the volume-average particle size. The diameter of the secondary particles is to be measured by this method. However, since a coarse powder generally has good dispersibility, the average particle diameter of the coarse powder measured by the above measuring equipment can be regarded almost as a volume-average primary particle diameter.

The bulk density was determined by weighing out 100 ml (cm³) of a powder using a measuring cylinder and measuring the mass of the same.

The specific surface area was measured by the BET method by using NOVA2000E (manufactured by SYSMEX).

For the elemental analysis, ICP emission spectrometry was performed by using ICPS-8000E (manufactured by Shimadzu Corporation).

### Examples 1 to 3, Comparative Examples 1 to 7

### [Production of a Sintered Body]

A primary powder of tungsten having an average particle diameter of 0.5 μm (particle diameter range: 0.05 to 8 μm) was obtained by reducing tungsten trioxide with hydrogen. Into the powder, 0.40 mass % of a crystal silicon powder having an average diameter of 0.8 μm (particle diameter range: 0.1 to 16 μm) was mixed and the mixture was left to stand in vacuum at 1,420° C. for 30 minutes. The mixture was cooled to room temperature and the aggregated product was pulverized to obtain a granulated powder having an average particle diameter of 75 μm (particle diameter range: 28 to 180 μm), a bulk density of 3.0 g/cm³, a specific surface area of 1.3 m²/g and a silicon content of 0.40 mass %, an oxygen content of 0.52 mass %, and a nitrogen content of 0.04 mass %. The powder was formed with a tantalum wire having a diameter of 0.29 mm vertically implanted in the formed body, and the formed body was sintered in vacuum at 1,500° C. for 30 minutes to thereby obtain a sintered body mainly comprising tungsten and having a size of 1.0×1.5×4.5 mm (powder weight: 64 mg, specific surface area: 0.71 m²/g).

A capacitor element using the sintered body as an anode body was produced by plugging the lead wires of 64 pieces of the anode bodies into the sockets of a jig disclosed in WO 2010/107011 publication, and forming a dielectric layer by means of chemical formation, a semiconductor layer, a carbon layer and a silver layer sequentially. A high-temperature heat treatment after the chemical formation was conducted by separating the sockets, in which the anode bodies were set, from the sockets in the front row fixed onto the substrate of the jig.

[Chemical Formation Treatment]

Using an aqueous solution of 3 mass % of ammonium persulfate as a chemical formation solution, a part of the tantalum wire and the anode body was immersed in the solution and subjected to chemical formation at 50° C., initial current density of 2 mA/anode body, 10 V for four hours. Subsequently, the anode body was washed with water, the water was substituted with alcohol, and the anode body was dried at a high temperature of 190° C. for 15 minutes to form a dielectric layer comprising amorphous tungsten trioxide. The dielectric layer contains part of silicon.

[Formation of a Semiconductor Layer]

1) Chemical Polymerization Process

The anode body having formed a dielectric layer thereon was immersed in 10 mass % of ethylenedioxythiophene ethanol solution for two minutes and dried in the air for two minutes. Next, the anode body was immersed in 10 mass % of iron toluenesulfonate aqueous solution and allowed to react in the air at 60° C. for ten minutes. The series of the operations was repeated three times in total.

2) Electrolytic Polymerization—Post-Chemical Formation Process

As an electrolytic polymerization liquid, a mixed solvent of 70 mass % of water and 30 mass % of ethylene glycol, to which 4 mass % of anthraquinone sulfonic acid and ethylenedioxythiophene in a saturated amount or more were added, was prepared. A predetermined part of the anode body was immersed in the electrolytic polymerization liquid; and electrolytic polymerization was conducted while stirring the liquid at 23° C. and a constant current of 60 μA/anode body for 60 minutes. After the completion of the electrolytic polymerization, the anode body was washed with water, the water was substituted with alcohol, and the anode body was dried at 105° C. for 15 minutes.

Subsequently, using the above-described chemical formation solution, application of voltage was started 23° C. and initial current density of 0.5 mA/anode body (constant current), and after the voltage reached 7 V, post-chemical formation was conducted at a constant voltage of 7 V for 15 minutes.

This series of the electrolytic polymerization and post-chemical formation was repeated six times in total to form a semiconductor layer comprising a conductive polymer on the dielectric layer. Note that the initial current density in the second electrolytic polymerization or later was set to 60 μA for the second time, 80 μA for the third to fifth time, and 120 μA for the for the sixth time, respectively.

[Formation of an Electrically Conductive Layer]

Furthermore, a carbon layer was formed on the semiconductor layer, a silver layer was formed on the carbon layer by solidifying a silver paste except for the face in which a tantalum lead wire was implanted. The resultant product was dried at 105° C. for 15 minutes to thereby produce a tungsten capacitor element.

[Aging, Property Evaluation]

64 pieces of the produced capacitor elements had an average capacitance of 230 μF at a bias voltage of 2.5 V and frequency of 120 Hz.

Next, aging in Process A was conducted under the conditions of the temperature, the humidity, and the application of voltage shown in Table 1. The measurement results of LC (average value of 64 elements, applied voltage: 7V) are shown in Table 1. The LC of the capacitor elements were measured by arraying 64 pieces of electrically conductive mats made by cutting commercially-available urethane foam having a thickness of 1 millimeter into 2-millimeter squares in a line on a rectangle-shaped stainless steel plate connected to the cathode of a power source, thereby electrically connecting the mats, and the surface of the element opposing to the surface having a tantalum lead wire implanted was pressed on the mat to form a circuit for measuring. Here, the resistance value per capacitor element from the surface of the stainless steel plate to the contact surface between the capacitor element and the conductive mat was 9,000Ω. The LC values in Table 1 are the values 30 seconds after applying a voltage.

TABLE 1

| | Ambient conditions | | Applied | | LC at |
|---|---|---|---|---|---|
| | Temperature | Humidity | voltage | | 7 V |
| | (° C.) | (% RH) | (V) | Time (hour) | (μA) |
| Example 1 | 15 | 75 | 3.5 | 14 | 115 |
| Example 2 | 30 | 80 | 6.0 | 8 | 109 |
| Example 3 | 50 | 90 | 8.0 | 4 | 118 |
| Comparative | 13 | 75 | 3.5 | 14 | 224 |
| Example 1 | | | | | |
| Comparative | 55 | 90 | 8.0 | 4 | 896 |
| Example 2 | | | | | |
| Comparative | 50 | 70 | 8.0 | 4 | 424 |
| Example 3 | | | | | |
| Comparative | 15 | 70 | 3.5 | 14 | 371 |
| Example 4 | | | | | |
| Comparative | 50 | 90 | 9.0 | 4 | 1302 |
| Example 5 | | | | | |
| Comparative | 50 | 90 | 3.0 | 80 | 440 |
| Example 6 | | | | | |

| | | | |
|---|---|---|---|
| Comparative | No aging | No aging | 446 |
| Example 7 | | | |

### Examples 4 to 6, Comparative Examples 8 to 10

Tungsten capacitor elements were produced in the same way as in Example 1 except that silicon was not added when a granulated powder was produced and the formation voltage and the post-formation voltage were set to 13 V and 8 V, respectively. The average capacitance of 64 elements was 177 μF. After applying a voltage of 8 V, the average LC value was 519 μA.

Next, aging in Process B was conducted under the conditions of the temperature, the humidity, and the application of voltage shown in Table 2. Subsequently, aging in Process A was conducted under the conditions of the temperature, the humidity, and the application of voltage shown in Table 2. The measurement values of LC of the capacitor elements (average value of 64 elements, applied voltage: 8V) after Process A and after Process B (final value) are shown in Table 2.

TABLE 2

| | | | | | | | | | LC at 8 V | |
|---|---|---|---|---|---|---|---|---|---|---|
| | Process B | | | | Process A | | | | After | Final |
| | Temperature | | | Time | Temperature | | | Time | Process | value |
| | ° C. | Humidity % | Voltage V | hour | ° C. | Humidity % | Voltage V | hour | B (μA) | (μA) |
| Example 4 | 55 | 90 | 0 | 6 | 20 | 80 | 7.0 | 32 | 1368 | 75 |
| Example 5 | 85 | 50 | 0 | 4 | 40 | 85 | 8.0 | 49 | 2036 | 64 |
| Example 6 | 55 | 50 | 0 | 5 | 15 | 90 | 8.0 | 26 | 647 | 80 |
| Comparative | 60 | 90 | 0 | 5 | 55 | 90 | 8.0 | 26 | 2395 | 1824 |
| Example 8 | | | | | | | | | | |
| Comparative | 60 | 90 | 5.0 | 5 | 55 | 90 | 8.0 | 26 | 2448 | 2024 |
| Example 9 | | | | | | | | | | |
| Comparative | 50 | 45 | 0 | 5 | 55 | 85 | 8.0 | 9 | 538 | 819 |
| Example 10 | | | | | | | | | | |

### Reference Example 1

A primary powder average particle diameter of 0.4 μm obtained by reducing potassium fluorotantalate with sodium was granulated in vacuum at 1,300° C. to obtain an aggregated product. The product was pulverized to obtain a secondary powder having an average particle diameter of 110 μm (particle diameter range: 26 to 180 μm). The secondary powder was formed in the same way as in Example 1, and sintered in vacuum at 1,340° C. for 30 minutes to obtain a sintered body having a shape similar to that of the sintered body in Example 1 (mass: 41 mg). Next, a dielectric layer, a semiconductor layer, a carbon layer and a silver layer were sequentially formed in the same way as in Example 1 to produce tantalum solid electrolytic capacitor elements. The average capacitance of the elements was 220 μF and the LC value after applying a voltage of 7 V was 97 μA, resulting in CV of 0.1 or less at this stage. Further, the aging in Process A was conducted under the same conditions as those in Example 1 in Table 1, but the LC value resulted in 103 μA and showed no improvement.

1. A method for producing a capacitor element in which a dielectric layer, a semiconductor layer, a carbon layer and an electrically conductive layer are sequentially formed on a predetermined part of an anode body obtained by forming a powder mainly comprising tungsten and sintering the formed body, comprising process A of applying a voltage of ⅓ to ⅘ of the chemical formation voltage to the capacitor element having the electrically conductive layer formed on the anode body under conditions of a temperature of 15 to 50° C. and a humidity of 75 to 90% RH.

2. A method for producing a capacitor element in which a dielectric layer, a semiconductor layer, a carbon layer and an electrically conductive layer are sequentially formed on a predetermined part of an anode body obtained by forming a powder mainly comprising tungsten and sintering the formed body, comprising process B of retaining the capacitor element having the electrically conductive layer formed on the anode body without applying a voltage at a temperature more than 50° C. and 85° C. or less and a humidity of 50 to 90% RH and then process A of applying a voltage of ⅓ to ⅘ of the chemical formation voltage to the capacitor element under conditions of a temperature of 15 to 50° C. and a humidity of 75 to 90% RH.

3. The method for producing a capacitor element as claimed in claim 1, wherein the powder mainly comprising tungsten contains tungsten silicide only in a particle surface region and having a silicon content of 0.05 to 7.0 mass %.

4. The method for producing a capacitor element as claimed in claim 2, wherein the powder mainly comprising tungsten contains tungsten silicide only in a particle surface region and having a silicon content of 0.05 to 7.0 mass %.
